(19) United States
(12) Patent Application Publication
(10) Pub. No.: US 2005/0075896 A1
(43) Pub. Date: Apr. 7, 2005

(54) Method of creating an audio/video presentation for funerals

(76) Inventor: John N. Dodgen, Humboldt, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 10/680,672

(22) Filed: Oct. 7, 2003

(51) Int. Cl. G06F 17/60

(52) U.S. Cl. 705/1

(57) ABSTRACT

The present invention is directed a method of celebrating a person's life by attendees at a funeral after the person's death. The method comprises the steps of causing the person, while alive, to create an audio/video presentation that would welcome the attendee to the person's funeral and include personal comments to the attendee in a generally uplifting sense about the occasion of the funeral. The method further comprises storing the audio/video with instructions that the presentation be played at the person's funeral, and publicly playing the presentation at the person's funeral for the attendees at the funeral to see and hear.

### BACKGROUND OF THE INVENTION

The present invention relates to audio/video presentations and, more specifically, to a method of creating an audio/video presentation to be played at a funeral.

Upon an individual's death, it is common to have a funeral or visitation at a funeral home where friends and family may view the decedent's body and pay their last respects. As funerals and visitations are painful occasions for the bereaved, families often have pictures and mementos of the deceased on display so that mourners may recall more favorable times.

In more recent times, it has become common for families to create funeral videos or audiovisual presentations to be played during the funeral or visitation. As described in U.S. Pat. No. 6,324,736, such recordings often include selected portions of home videos previously taken of the deceased, combined with still photographs and set to music. These presentations allow the bereaved to reflect on the decedent's life and his or her accomplishments. Because of advances in amateur videography as well as computerized editing, seamless compilations of the decedent's life may be easily created with relative ease and professionalism.

Yet the prior art does not provide a way in which the deceased may personally address the mourners at his or her funeral. While presenting a compilation of past home videos and still photographs may provide some assistance to the bereaved in the grieving process, these prior art presentations do not provide the individualized comfort that a personal message from the deceased may provide.

It is therefore a principal object of this invention to provide a method in which the deceased may personally address the bereaved at his or her funeral.

A further object of this invention is to provide a method of celebrating a person's life at his or her funeral by recording a message from the person while he or she is still alive.

These and other objects will be apparent to those skilled in the art.

### BRIEF SUMMARY OF THE INVENTION

The present invention is a method of celebrating a person's life by attendees at a funeral after the person's death. The method comprises the steps of causing the person, while alive, to create an audio/video presentation that would welcome the attendee to the person's funeral and include personal comments to the attendee in a generally uplifting sense about the occasion of the funeral. The method further comprises storing the audio/video with instructions that the presentation be played at the person's funeral, and publicly playing the presentation at the person's funeral for the attendees at the funeral to see and hear.

### BRIEF DESCRIPTION OF THE DRAWINGS

FIG. 1 is side view of a funeral visitation shown with the present invention.

### DESCRIPTION OF THE PREFERRED EMBODIMENT OF THE INVENTION

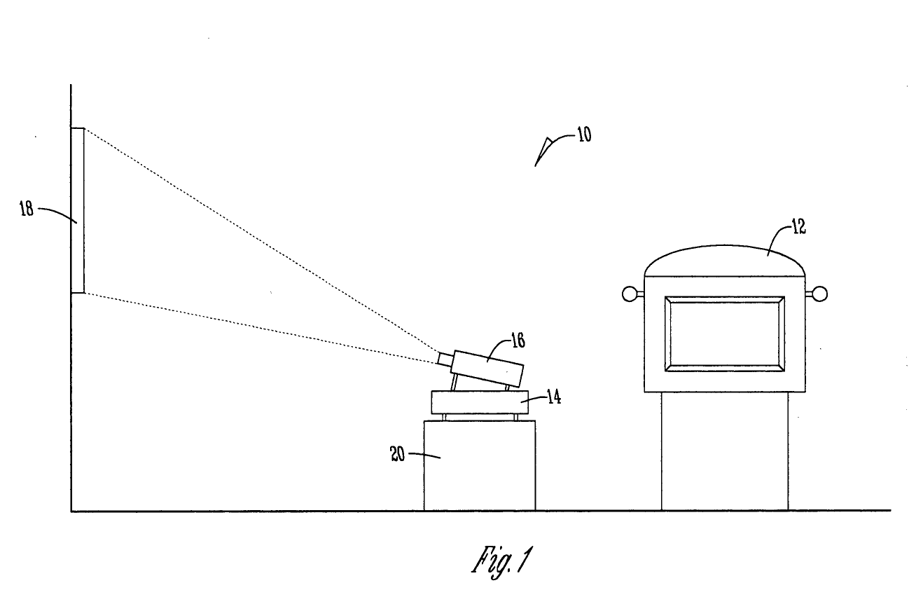

With reference to FIG. 1, a funeral visitation 10 is shown with a casket 12 retaining the deceased, a device 14 for playing a pre-recorded audio/video presentation, a projector 16 for projecting the video portion of the presentation onto a screen 18, and a speaker 20 for resonating the audio portion of the presentation.

The device 14 allows the pre-recorded audio/video presentation to be played at the funeral. Because the presentation may be include audio and/or video portions, the device 14 may be a video cassette recorder, tape player, compact disc player, digital video disc player, laptop computer, or any other device that plays audio and/or video strings.

For presentations that include a video portion, the video signal from device 14 is fed to a projector 16, which projects the image upon a conventional screen 18. Alternatively, the video signal may be fed to a television set or monitor (not shown), or to any other device that receives video signals and displays the corresponding images.

For presentations with an audio portion, the audio signal from device 14 is fed to a speaker 20 for broadcasting the audio portion about the funeral parlor. Alternatively, the audio signal from device 14 may be fed to a stereo system (not shown) or to any other device that receives audio signals and broadcasts the corresponding sounds.

The presentation includes an audio portion, video portion, or both. While still living, a person records an audiovisual presentation in which he or she may personally address those attendees at his or her upcoming funeral. Alternatively, the deceased may choose to record only an audio segment in which he or she speaks to the attendees. The presentation is made with any conventional recording device, including a video camera recorder, tape player, digital camera device, or the like. The presentation is then stored on any conventional medium, including a tape, compact disc, digital video disc, floppy disc, or the like.

After the presentation is made, the person stores the recording medium containing the presentation with the funeral home along with instructions that the presentation be played at his or her upcoming funeral. Alternatively, the person may give the recording to a friend or family member with similar instructions.

After the person has passed away, the presentation is played at his or her funeral or visitation. Through this presentation, the deceased personally addresses those in attendance at his or her funeral. The deceased therefore is able to greet and welcome those in attendance, as well as create a spirit of celebration at the event for a life well lived.

It is therefore seen that by recording and storing a message from a person while he or she is still alive, this invention permits the person to personally address the bereaved at his or her funeral.

1. A method of celebrating a person's life by attendees at a funeral after the person's death, comprising,
causing the person, while alive, to create a message presentation that would welcome the attendee to the person's funeral and include personal comments to the attendee in a generally uplifting sense about the occasion of the funeral,
storing the message presentation with instructions that the message presentation be played at the person's funeral, and
publicly playing the message presentation at the person's funeral for the attendees at the funeral to see and hear.

2. The method of claim 1 wherein the message presentation is projected on a screen.

3. The method of claim 1 wherein the message presentation is an audio presentation.

4. The method of claim 2 wherein the message presentation is a combination video-type and audio presentation.

5. The method of claim 1 wherein the message presentation is an audio/video presentation.
